(19) United States
(12) Patent Application Publication
(10) Pub. No.: US 2009/0022961 A1
(43) Pub. Date: Jan. 22, 2009

(54) INTERLAYER FOR LITHOGRAPHIC PLATES

(76) Inventors: Bernd Strehmel, Berlin (DE); Harald Baumann, Osterode/Harz (DE); Eiji Hayakawa, Tsunomiya (JP); Koji Hayashi, Tatebayashi (JP); Jianbing Huang, Trumbull, CT (US); Hideo Sakurai, Ageo (JP); Saraiya Shashikant, Fort Collins, CO (US); Detlef Pietsch, Badenhausen (DE)

Correspondence Address: EASTMAN KODAK COMPANY;PATENT LEGAL STAFF, 343 STATE STREET, ROCHESTER, NY, 14650-2201, US

(21) Appl. No.: 11/574,022

(22) PCT Filed: Sep. 1, 2004
(86) PCT No.: PCT/US04/28341

§ 371 Date: Feb. 21, 2007

(51) Int. Cl. B41M 5/00; G03C 1/00; B05D 3/02; B32B 27/30; G03C 1/74

(52) U.S. Cl. 428/195.1; 430/270.1; 427/144; 428/341; 428/522; 428/414

(57) ABSTRACT

Lithographic substrate comprising (a) a dimensionally stable plate- or foil-shaped support, (b) an aluminum oxide layer provided on at least one side of the support (a), and (c) an interlayer applied onto the aluminum oxide layer comprising a hydrophilic polymer comprising structural units derived from the following compounds: (a1) at least one compound comprising both polyalkylene oxide chains and at least one structural unit which is free-radical polymerizable, and (a2) at least one monomer capable of copolymerizing with the free-radical polymerizable structural unit of (a1) and furthermore comprising at least one acidic functional group with pKs<5, wherein the acidic functional group can be present as a free acid group or in the form of a salt.

The present invention relates to a substrate for lithographic printing plates, in particular a substrate with an interlayer made from an organic polymer. The invention furthermore relates to lithographic printing plate precursors and lithographic printing plates comprising such a substrate, as well as to a process for the production of such a substrate.

The technical field of lithographic printing is based on the immiscibility of oil and water, wherein the oily material or the printing ink is preferably accepted by the image area, and the water or fountain solution is preferably accepted by the non-image area. When an appropriately produced surface is moistened with water and a printing ink is applied, the background or non-image area accepts the water and repels the printing ink, while the image area accepts the printing ink and repels the water. The printing ink in the image area is then transferred to the surface of a material such as paper, fabric and the like, on which the image is to be formed. Generally, however, the printing ink is first transferred to an intermediate material, referred to as “blanket”, which then in turn transfers the printing ink onto the surface of the material on which the image is to be formed; this technique is referred to as offset lithography.

Usually, a lithographic printing plate precursor (in this context the term “printing plate precursor” refers to a coated printing plate prior to exposure and developing) comprises a radiation-sensitive coating applied onto a substrate, usually on aluminum basis. If a coating reacts to radiation such that the exposed portion becomes so soluble that it is removed during the developing process, the plate is referred to as “positive working”. On the other hand, a plate is referred to as “negative working” if the exposed portion of the coating is hardened by the radiation. In both cases, the remaining image area accepts printing ink, i.e. is oleophilic, and the non-image area (background) accepts water, i.e. is hydrophilic. The differentiation between image and non-image areas takes place during exposure. Usually, an aqueous, strongly alkaline developer is used to remove the more soluble portions of the coating.

Independently of the type of material the substrate is made from, e.g. aluminum foils, plastic films or paper, the majority of commercially available printing plate precursors has an aluminum oxide layer on the substrate surface since it exhibits a high degree of mechanical abrasion resistance necessary during the printing process. On the one hand, this oxide layer is already hydrophilic to some degree, which is significant for repelling the printing ink; however, on the other hand, it is so reactive that it can interact with components of the radiation-sensitive layer. The aluminum oxide layer can cover the surface of the substrate completely or partially.

Usually, a substrate, in particular an aluminum substrate with aluminum oxide layer, is provided with a hydrophilic protective layer (also referred to as “interlayer”) before the radiation-sensitive layer is applied. This hydrophilic layer improves the water acceptance of the (non-printing) background areas of a lithographic printing plate and improves the repulsion of the printing ink in these areas. A suitable protective layer also ensures that during developing the soluble portions of the radiation-sensitive layer are removed easily and residue-free from the substrate so that clean background areas are obtained during printing. Without such a residue-free removal, what is referred to as toning would occur during printing, i.e. the background areas would accept printing ink. Without a suitable protective layer, the aluminum layer can be stained by dyes that are present as so-called exposure indicators or colorants in the radiation-sensitive layers (so called “staining”); furthermore, the correctability of a printing plate can be made more difficult. On the other hand, the adhesion of the image areas on the aluminum oxide layer should not be affected by the hydrophilic layer or should even be improved. The interlayer should also protect the aluminum oxide layer against corrosion during developing with a strongly alkaline developer (pH value >11.5). Otherwise, such an attack would lead to a sludging of the developer bath. The interlayer can be applied to one or both sides of the substrate; depending on the amount that is applied, the surface of the side(s) of the substrate can be fully or only partially covered.

Document DE 25 327 69 A1 describes lithographic printing plate precursors on the basis of negative diazo resins having a sodium silicate interlayer. While the adhesion of the image areas to this interlayer is very good, it has been found that the photosensitivity of these plates is greatly affected by storage at elevated temperatures and humidity. Furthermore, the process of applying the interlayer poses problems, for example, drying of the alkaline sodium silicate solution on parts of the apparatus leads to residues which are hard to remove.

The use of polyvinylphosphonic acid or salts thereof as well as copolymers of vinylphosphonic acid with acrylic monomers as interlayers in lithographic printing plate precursors is e.g. suggested in DE 1 134 093 C, U.S. Pat. No. 4,153,461 and EP 0 537 633 B1. However, such a layer does not provide optimum protection for the aluminum oxide layer so that sludging of the developer takes place; furthermore, such printing plates have a tendency to cause toning after the press is re-started.

EP 0 154 200 A1 describes printing plates comprising two sublayers, a silicate layer on the substrate and a PVPA layer on top of that. EP 0 681 221 A1 and EP 0 689 941 C1 also describe combinations of two sublayers. However, the application of two sublayers is complicated and expensive and therefore not desirable from an economic point of view.

U.S. Pat. No. 5,807,659 describes an interlayer obtained by applying a polymer with Si—O—Si bond, with the polymer having been obtained by hydrolysis and polycondensation of an organic silicon compound of the type SiR₄ (wherein R is a hydrolysable group) with an organic silicon compound of the type R₁Si(R₂)₃ (wherein R₁ is an addition reactive functional group and R₂ is a hydrolysable alkoxy group or —OCOCH₃). However, the use of such an interlayer leads to the problem of toning, especially when the press is re-started.

It is the object of the present invention to provide a lithographic substrate with an interlayer which combines good adhesion and good developability, protects metallic substrates against corrosion, prevents sludging of the developer, allows re-starting of the press without causing toning problems and furthermore does not affect the sensitivity and storage stability of the radiation-sensitive layer.

This object is achieved by a lithographic substrate comprising
(a) a dimensionally stable plate- or foil-shaped support,
(b) an aluminum oxide layer provided on at least one side of the support (a), and
(c) a hydrophilic layer applied onto the aluminum oxide layer comprising at least one polymer comprising structural units derived from the following compounds:
   (a1) at least one compound comprising both polyalkylene oxide chains and at least one structural unit which is free-radical polymerizable,
   and
   (a2) at least one monomer capable of copolymerizing with the free-radical polymerizable structural unit of (a1) and furthermore comprising at least one acidic functional group with pKₛ<5, wherein the acidic functional group can be present as a free acid group or in the form of a salt.

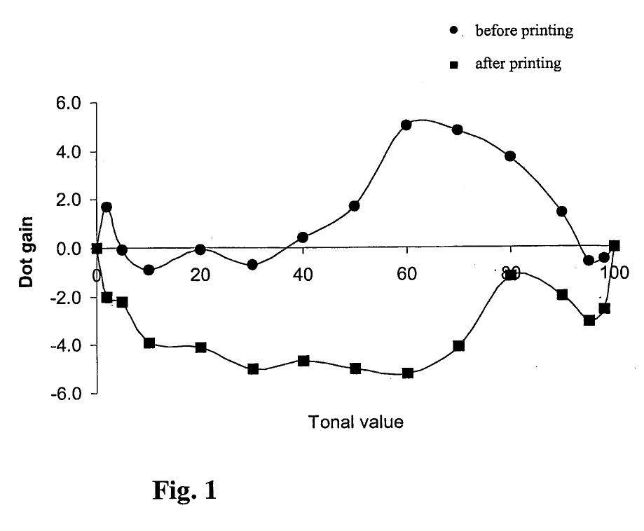

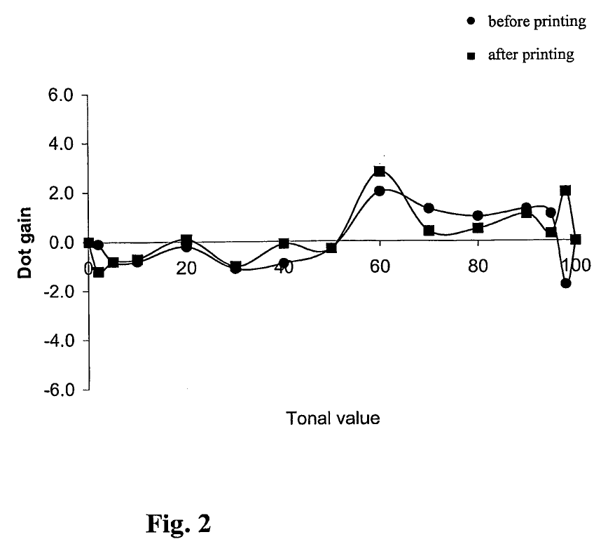

FIGS. 1 and 2 graphically illustrate the dot gain of a calibrated plate as a function of the tonal value as determined in Comparative Example 2 (FIG. 1) and Example 33 (FIG. 2).

The polymer used for the interlayer of the present invention comprises structural units derived from the following compounds:
(a1) at least one compound comprising both polyalkylene oxide chains and at least one structural unit which is free-radical polymerizable,
and
(a2) at least one monomer capable of copolymerizing with the free-radical polymerizable structural unit of (a1) and furthermore comprising at least one acidic functional group with pKₛ<5, wherein the acidic functional group can be present as a free acid group or in the form of a salt.

Optionally, the polymer can also comprise structural units derived from a comonomer (a3) different from monomer (a2), which preferably has hydrophilic properties and comprises at least one free-radical polymerizable group. By means of comonomer (a3), physical properties, such as e.g. solubility in H₂O, can be adjusted.

The compound (a1) preferably comprises polyethylene oxide and/or polypropylene oxide chains; within the framework of the present invention, the prefix “poly” also encompasses oligomers.

The free-radical polymerizable structural unit of compound (a1) is preferably derived from acrylic acid and/or methacrylic acid. The term “(meth)acrylic acid” encompasses both acrylic acid and methacrylic acid; analogously, the same applies to “(meth)acrylate”.

Suitable examples of compound (a1) include:

Poly(ethylene glycol) methacrylate,
poly(ethylene glycol) acrylate,
poly(propylene glycol) methacrylate,
poly(propylene glycol) acrylate,
monoesters of acrylic acid or methacrylic acid with block copolymers of ethylene oxide and/or propylene oxide,
the reaction product of 2,4-toluene diisocyanate-terminated polyethylene glycol, polypropylene glycol, block copolymer of polyethylene glycol and polypropylene glycol or statistical poly(ethylene glycol-propylene glycol) copolymer with hydroxyalkyl acrylate or methacrylate (for example hydroxyethyl acrylate or methacrylate) or allyl alcohol,
the monoreaction product of isocyanatoalkyl acrylate or methacrylate (in particular isocyanatoethyl acrylate or methacrylate) with polyethylene glycol, polypropylene glycol, block copolymer of polyethylene glycol and polypropylene glycol or statistical poly(ethylene glycol-propylene glycol) copolymer,
ester or ether derivatives of poly(alkylene glycol) acrylate and methacrylate (in particular of poly(ethylene glycol) acrylate and methacrylate).

Especially preferred examples of compound (a1) include

Poly(ethylene glycol) acrylate, poly(ethylene glycol) methacrylate, alkyl ethers of poly(ethylene glycol) acrylate, alkyl ethers of poly(ethylene glycol) methacrylate, poly(propylene glycol) acrylate, poly(propylene glycol) methacrylate and poly(ethylene glycol) (meth)acrylate phosphoric acid monoesters.

In addition to a free-radical polymerizable group, monomer (a2) comprises at least one acidic functional group with pKₛ<5. The at least one acidic functional group is preferably selected from a carboxylic acid group, a sulfonic acid group, a phosphonic acid group, a phosphoric acid group and mixtures thereof. The acidic functional group can be present as a free acid group or in the form of a salt.

Suitable examples of monomer (a2) include acrylic acid, methacrylic acid, crotonic acid, maleic acid anhydride ring-opened with a C₁-C₆ alkanol, vinylbenzoic acid, vinylphosphonic acid, vinylsulfonic acid, vinylbenzolsulfonic acid, monoesters of phosphoric acid with hydroxyalkyl(meth)acrylate (in particular hydroxyethyl methacrylate and hydroxyethyl acrylate) or allyl alcohol and sulfopropyl(meth)acryloylethyldialkyl-ammoniumhydroxides.

Especially preferred monomers (a2) are (meth)acrylic acid, vinylphosphonic acid, the monoester of phosphoric acid with hydroxyethyl(meth)acrylate and (meth)acryloyl dimethyl-(3-sulfopropyl)-ammoniumhydroxides.

The optional free-radical polymerizable comonomer (a3) preferably results in a hydrophilic homopolymer upon homopolymerization. Suitable examples of comonomer (a3) include (meth)acrylamide, N-vinylpyrrolidone, hydroxyalkyl(meth)acrylate (in particular hydroxyethyl acrylate and hydroxyethyl methacrylate), allyl alcohol and N-vinylimidazole.

The molar ratio of compounds (a1), (a2) and optionally (a3) is not particularly restricted. Preferably, the structural units derived from (a1) account for 5 to 95 wt.-% of the interlayer polymer, based on all the structural units, especially preferred 20 to 80 wt.-%.

Preferably, the structural units derived from (a2) account for 5 to 95 wt.-% of the interlayer polymer, based on all the structural units, especially preferred 20 to 80 wt.-%.

Preferably, the optional structural units derived from (a3) account for 0 to 50 wt.-% of the interlayer polymer, based on all the structural units, especially preferred 0 to 30 wt.-%.

Optionally, hydrophobic comonomers (a4) with at least one free-radical polymerizable group, such as styrene, can also be used; however, their amount should not exceed 15 wt. %.

The copolymerization of compound (a1), monomer (a2), optionally comonomer(s) (a3) and/or (a4) is preferably carried out in solution. Organic solvents or solvent mixtures, water, or mixtures of water and an organic solvent miscible with water can be used for this purpose. Preferably, both the starting components (a1) to (a4) and the product polymer are soluble therein.

According to a preferred embodiment, a solvent with negligible vapor pressure (i.e. the vapor pressure cannot be measured by means of commercially available osmometers) is used (such a solvent is also referred to as a “green solvent”), such as an ionic liquid; for more information on “green solvents” see “Ionic Liquids as Green Solvents: Progress and Prospects” by Robin D. Rogers and Kenneth R. Seddon, in ACS Symposium Series No. 856 and “Ionic Liquids in Synthesis” by Peter Wasserscheid and Thomas Welton, Wiley—VCH 2003.

It has been found that polymers that have been prepared by polymerization in a solvent with negligible vapor pressure, such as e.g. an ionic liquid, differ in their properties from polymers prepared by solvent polymerization of the same monomers in a solvent with measurable vapor pressure. According to one embodiment, a polymer with the structural units as defined above prepared by polymerization in an ionic liquid is used as interlayer polymer. For the use of the polymer as interlayer polymer in lithographic substrates according to the present invention, it is not necessary that the ionic liquid is completely removed from the polymer. It is also possible to prepare the interlayer polymers without an ionic liquid and then mixing the resulting polymers with an ionic liquid.

The following ionic liquids can for example be used for polymerization:

Imidazolium salts of the general formula (A)

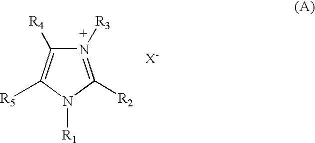

wherein X is for example selected from BF₄⁻, PF₆⁻, dimethylphosphate, tosylate, methylsulfate and

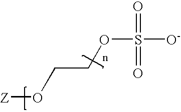

(n≧1, Z=H or alkyl),
R₁ and R₃ are for example selected from alkyl substituents and

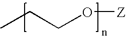

(n≧1, Z=H or alkyl), and
R₂, R₄ and R₅ are independently selected for example from alkyl substituents,

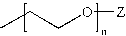

(n≧1, Z=H or alkyl) and H,
pyridinium salts of the general formula (B)

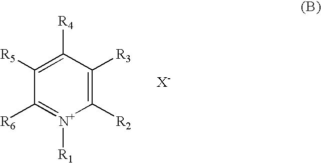

wherein X⁻ is for example selected from BF₄⁻, PF₆⁻, dimethylphosphate, tosylate, alkylsulfate and

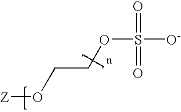

(n≧1, Z=H or alkyl),
R₁ is for example selected from an alkyl substituent and

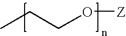

(n≧1, Z=H or alkyl) and
R₂, R₃, R₄, R₅ and R₆ are independently selected for example from alkyl substituents,

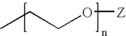

(n≧1, Z=H or alkyl) and H,
phosphonium salts of the general formula (C)

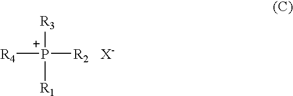

wherein X⁻ is for example selected from BF₄^{-, PF}₆^{—}, dimethylphosphate, tosylate, methylsulfate and

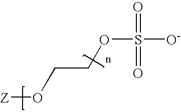

(n≧1, Z=H or alkyl),
R₁, R₂, R₃ and R₄ are independently selected for example from alkyl substituents and

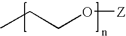

(n≧1, Z=H or alkyl) and
ammonium salts of the general formula (D)

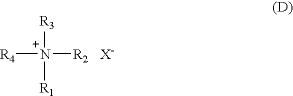

wherein X⁻ is for example selected from BF₄^{—}, PF₆⁻, dimethylphosphate, tosylate, methylsulfate and

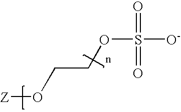

(n≧1, Z=H or alkyl)
and R₁, R₂, R₃ and R₄ are independently selected for example from alkyl substituents and

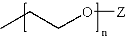

(n≧1, Z=H or alkyl).

A dimensionally stable plate or foil-shaped material is used as a support. Preferably, a material is used as dimensionally stable plate or foil-shaped material that has already been used as a support for printing matters. Examples of such supports include paper, paper coated with plastic materials (such as polyethylene, polypropylene, polystyrene), a metal plate or foil, such as e.g. aluminum (including aluminum alloys), zinc and copper plates, plastic films made e.g. from cellulose diacetate, cellulose triacetate, cellulose propionate, cellulose acetate, cellulose acetatebutyrate, cellulose nitrate, polyethylene terephthalate, polyethylene, polystyrene, polypropylene, polycarbonate and polyvinyl acetate, and a laminated material made from paper or a plastic film and one of the above-mentioned metals, or a paper/plastic film that has been metallized by vapor deposition. Among these supports, an aluminum plate or foil is especially preferred since it shows a remarkable degree of dimensional stability and is inexpensive. Furthermore, a composite film can be used wherein an aluminum foil has been laminated onto a plastic film, such as e.g. a polyethylene terephthalate film, or paper, or a plastic film onto which aluminum has been deposited by means of vapor deposition.

The following steps can for example be taken to generate the aluminum oxide layer on the supports mentioned above:

A metal support, in particular an aluminum support, is preferably subjected to a treatment selected from graining (e.g. by brushing in a dry state or brushing with abrasive suspensions, or electrochemical graining, e.g. by means of a hydrochloric acid electrolyte), anodizing (e.g. in sulfuric acid or phosphoric acid) and hydrophilizing. The aluminum oxide layer can also be applied on the above-mentioned supports by means of vapor deposition processes.

Within the framework of the present invention, supports with an aluminum oxide layer are referred to as “substrate”. The aluminum oxide layer can cover the surface of one or both sides of the support completely or partially. In the present invention, a support with both an aluminum oxide layer and an interlayer is referred to as “lithographic substrate”.

The details of the above-mentioned support pre-treatment, such as graining and anodizing, are known to the person skilled in the art.

An aluminum foil which preferably has a thickness of 0.1 to 0.7 mm, more preferred 0.15 to 0.5 mm, is an especially preferred support. It is preferred that the foil be grained (preferably electrochemically) and then show an average roughness of 0.2 to 1 μm, especially preferred 0.3 to 0.8 μm.

According to an especially preferred embodiment, the grained aluminum foil was furthermore anodized. The layer weight of the resulting aluminum oxide is preferably 1.5 to 5 g/m², especially preferred 2 to 4 g/m².

For preparing a lithographic substrate according to the present invention, a dimensionally stable support as described above is first provided with an aluminum oxide layer and then with an interlayer comprising a polymer comprising structural units derived from the following compounds:
(a1) at least one compound comprising both polyalkylene oxide chains and at least one structural unit which is free-radical polymerizable,
and
(a2) at least one monomer capable of copolymerizing with the free-radical polymerizable structural unit of (a1) and furthermore comprising at least one acidic functional group with pKₛ<5, wherein the acidic functional group can be present as a free acid group or in the form of a salt.

For this purpose, a solution of the interlayer polymer is prepared, preferably with a concentration of 0.01 to 10 wt.-%, based on the solvent, more preferred 0.05 to 5 wt.-%, particularly preferred 0.1 to 1 wt.-%. This solution is then applied using common coating processes such as e.g. dip coating, roller coating, spray coating, bar coating and coating with a slot coater. The solvent used in this process has a temperature of preferably 20 to 90° C. Dipolar aprotic solvents (such as DMF, DMSO, NMP and THF) can be used, as well as protic solvents (such as C₁-C₄ alkanols), water and mixtures of the above.

The solution can furthermore contain common additives such as thickening agents, surfactants, bactericides, fungicides etc.

If desired, an excess of solution can be removed by means of a doctor blade, a squeeze roll or by rinsing with water (preferably at a temperature of 20 to 80° C.) after a sufficiently long dwell time of the solution of the substrate.

The substrate treated with the solution is then dried using for example a hot-air dryer or an infrared dryer. Drying is preferably carried out at a temperature of 30 to 120° C., especially preferred 40 to 90° C.

The amount of interlayer on the substrate can be determined by determining the organic carbon at 1,100° C. A 5×1 cm strip is cut from a plate loaded with an interlayer, placed in a quartz tube and purged with oxygen. Then this sample is heated to 1,100° C. with a suitable temperature program. Calibrating experiments showed that the amount of CO₂ resulting from the combustion quantitatively corresponds to the amount of carbon contained in the interlayer polymer with which the substrate is coated. This process reveals the amount of interlayer on the substrate when the background signal is subtracted. This process is very sensitive and can therefore be used to determine even traces of interlayer polymer on the substrate; it does not require a removal of the interlayer polymer from the substrate, either. The preferred amount of interlayer is about 5 to 20 mg/m².

The lithographic substrate of the present invention is suitable for the production of all types of lithographic printing plate precursors, i.e. both positive working and negative working precursors, which can either be UV/VIS-sensitive (i.e. sensitive to radiation selected from a wavelength range of 320 nm to 750 nm) or IR-sensitive (i.e. sensitive to radiation selected from a wavelength range of more than 750 nm to 1,600 nm, preferably more than 750 nm to 1,350 nm) or heat-sensitive. The precursors can either be single-layer precursors or precursors having a multi-layer structure.

The lithographic substrate of the present invention can for example be coated with a negative working UV-sensitive coating on the basis of negative diazo resins as described, inter alia, in EP 0 752 430 B1, a negative working photopolymer layer sensitive to radiation of about 405 nm (see e.g. DE 103 07 451.1), a negative working photopolymer system sensitive to radiation from the visible range of the spectrum (e.g. EP 0 684 522 B1) or a negative working IR-sensitive layer based on free-radical polymerization (e.g. DE 199 06 823 C2).

Furthermore, the lithographic substrate of the present invention can be provided with a positive working UV-sensitive layer based on quinone diazides and novolaks, as described in U.S. Pat. No. 4,594,306, or a positive working IR-sensitive layer on the basis of a mixture of novolaks and IR dyes (see also EP 0 887 182 B1 and EP 1 101 607 A1).

Furthermore, the lithographic substrate of the present invention can be used for negative working single-layer IR-sensitive elements wherein the radiation-sensitive layer is rendered insoluble in or impenetrable by aqueous alkaline developer upon IR irradiation and preferably comprises
(i) at least one compound which forms an acid upon IR irradiation (in the following also referred to as “latent Bronsted acid”), and
(ii) a component cross-linkable by an acid (in the following also referred to as “cross-linking agent”) or a mixture thereof and
optionally
(iii) a binder resin or a mixture thereof.

Such systems are for example described in EP 0 625 728 B1 and EP 0 938 413 B1.

The lithographic substrate of the present invention can also be used for positive working dual-layer elements comprising, on the hydrophilic surface of the substrate, a first layer soluble in aqueous alkaline developer whose solubility is not changed by IR irradiation, and on top of that layer a top layer insoluble in aqueous alkaline developer which is rendered soluble in or penetrable by the developer upon IR irradiation.

Known principles can be applied for the top layer:
(a) A polymer insoluble in strongly alkaline aqueous developer (pH>11) is used which is rendered soluble in or penetrably by the developer by IR irradiation; such systems are for example described in U.S. Pat. No. 6,352,812.
(b) A polymer soluble in strongly alkaline aqueous developer (pH>11) is used whose solubility is reduced to such a high degree by the simultaneously present solubility inhibitor that the layer is not soluble or penetrable under developing conditions; the interaction between the polymer and the inhibitor is weakened by IR radiation to such a degree that the irradiated (heated) areas of the layer are rendered soluble in or penetrable by the developer. Such systems are for example described in U.S. Pat. No. 6,352,811 and U.S. Pat. No. 6,358,669. It is not necessary that the polymer and the solubility inhibitor are two separate compounds, but polymers can be used which at the same time have a solubility inhibiting effect, such as e.g. the functionalized resins described in US 2002/0,150,833 A1, U.S. Pat. No. 6,320,018 B and U.S. Pat. No. 6,537,735 B, such as e.g. functionalized novolaks.
(c) A polymer insoluble in aqueous alkaline developer with pH<11 (but soluble at pH>11) is used, which upon IR irradiation becomes soluble in such a developer with pH<11, and the irradiated element is developed with an alkaline developer with pH<11. Such a system is for example described in WO 02/14071.

The present invention is described in more detailed in the following examples; however, they are not intended to restrict the invention in any way.

### PREPARATION EXAMPLES

### 1. Synthesis Process S1

### Preparation of Copolymers S1-a to S1-d

In a mixture of n-propanol and water (4:1 parts by volume) x₁ g a1 and x₂ g a2 were dissolved, resulting in a 15 wt.-% solution. The resulting solution was purged with nitrogen and heated to 70° C. At 70° C., x₃ mole-% azobisisobutyronitrile AIBN (based on the monomer) were added, while purging with nitrogen was continued and the reaction temperature maintained. After 2 hours, the same amount of AIBN was again added to the polymerization mixture. The mixture was stirred for another 10 hours at the same reaction temperature, while purging with nitrogen was continued. Then the mixture was left to cool to room temperature and the excess solvent was evaporated off. The resulting oily product was added to a 10-fold excess of petroleum ether, causing a highly viscous product to precipitate. The petroleum ether was evaporated off until a constant mass of final product was obtained. The final product was then dried in a vacuum for 24 hours at 50° C. The resulting copolymer was examined by means of differential thermal analysis (DTA), differential calorimeter (DSC), IR-spectroscopy, elementary analysis and gel-permeation chromatography (GPC) and the acid value was determined by titration. Table 1 summarizes the educts used for the preparation of copolymers S1-a to S1-d as well as their amounts.

TABLE 1

| Copolymer | a1 | x₁ (g) | a2 | x₂ (g) | x₃ (mole-%) |
|---|---|---|---|---|---|
| S1-a | AA¹⁾ | 35 | PEGMA³⁾ | 15 | 0.2 |
| S1-b | AA | 15 | PEGMA | 35 | 0.2 |
| S1-c | MAA²⁾ | 35 | PEGMA | 15 | 0.2 |
| S1-d | MAA | 15 | PEGMA | 35 | 0.2 |

¹⁾Acrylic acid
²⁾Methacrylic acid
³⁾Poly(ethylene glycol) methacrylate with Mₙ = 526 g/mole

### 2. Synthesis Process S2

### Preparation of Copolymers S2-a and S2-b

x₁ g a1 and x₂ g a2 were dissolved in methyl ethyl ketone, resulting in a 15 wt.-% solution. The resulting solution was purged, with nitrogen and heated to 70° C.

At 70° C., x₃ mole-% AIBN (based on the monomer) were added, while purging with nitrogen was continued and the reaction temperature maintained. The polymer started to precipitate. After 2 hours, the same amount of AIBN was again added to the polymerization mixture and after 2 more hours, the same amount of AIBN was added once more. The mixture was stirred for another 10 hours at the same reaction temperature, while flushing with nitrogen was continued. The precipitated copolymer was isolated, washed with petroleum ether and then dried in a vacuum for 24 hours at 50° C. The resulting copolymer was examined by means of DTA, DSC, IR-spectroscopy, elementary analysis and GPC, and the acid value was determined by titration. Table 2 summarizes the educts used for the preparation of copolymers S2-a and S2-b as well as their amounts.

TABLE 2

| | | x₁ | | x₂ | x₃ |
|---|---|---|---|---|---|
| Copolymer | a1 | (g) | a2 | (g) | (mole-%) |
| S2-a | VPA⁴⁾ | 35 | PEGMA | 15 | 0.13 |
| S2-b | VPA | 15 | PEGMA | 35 | 0.13 |

⁴⁾Vinylphosphonic acid

### 3. Synthesis Process S3

### Preparation of Copolymers S3-a to S3-j

x₄ wt.-% solvent A were provided in a reaction flask, purged with nitrogen and heated to 70° C. Purging with nitrogen was continued throughout the entire reaction time.

x₁ g a1, x₂ g a2 and x₃ mole-% AIBN (based on the monomer) were dissolved in solvent B resulting in a 50 wt.-% solution. The solution was transferred to a dropping funnel and slowly added drop-wise to solvent A in the reaction flask. After the entire solution had been added, the reaction mixture was stirred for 10 hours while the reaction mixture was allowed to slowly cool to room temperature. Excess solvent was removed in a vacuum. The product was purified by repeated dissolving in suitable solvents and precipitation. Then the product was dried in a vacuum for 24 hours at 50° C. The resulting copolymer was examined by means of DTA, DSC, IR-spectroscopy, elementary analysis, NMR-spectroscopy and GPC, and the acid value was determined by titration.

Table 3 summarizes the educts used for the preparation of copolymers S3-a to S3-j as well as their amounts and the solvents used.

TABLE 3

| | | x₁ | | x₂ | x₃ | x₄ | | |
|---|---|---|---|---|---|---|---|---|
| Copolymer | a1 | (g) | a2 | (g) | (mole-%) | (wt.-%) | A | B |
| S3-a | AA | 35 | PEGMA | 15 | 0.6 | 85 | PROH-W⁷⁾ | MEK⁸⁾ |
| S3-b | AA | 15 | PEGMA | 35 | 0.6 | 85 | PROH-W | MEK |
| S3-c | MAA | 35 | PEGMA | 15 | 0.6 | 85 | PROH-W | MEK |
| S3-d | MAA | 15 | PEGMA | 35 | 0.6 | 85 | PROH-W | MEK |
| S3-e | MEP⁵⁾ | 35 | PEGMA | 15 | 0.6 | 85 | PROH-W | PROH-W |
| S3-f | MEP | 15 | PEGMA | 35 | 0.6 | 85 | PROH-W | PROH-W |
| S3-g | MEDMSPA⁶⁾ | 35 | PEGMA | 15 | 0.6 | 85 | PROH-W | PROH-W |
| S3-h | MEDMSPA | 15 | PEGMA | 35 | 0.6 | 85 | PROH-W | PROH-W |
| S3-i | MPEP⁹⁾ | 35 | PEGMA | 15 | 0.6 | 85 | PROH-W | PROH-W |
| S3-j | MPEP | 15 | PEGAM | 35 | 0.6 | 85 | PROH-W | PROH-W |

⁵⁾Methacryloylethyl phosphate
⁶⁾Methacryloylethyl dimethylsulfopropyl-ammoniumhydroxide
⁷⁾Mixture of n-propanol and water (4:1 parts by volume)
⁸⁾Methyl ethyl ketone
⁹⁾Methacryloylpolyethylene glycol phosphate

### 4. Synthesis Process S4

### Preparation of Copolymers S4-a to S4-d

x₄ wt.-% solvent A were provided in a reaction flask, purged with nitrogen and heated to 70° C. Purging with nitrogen was continued throughout the entire reaction time.

x₁ g a1, x₂ g a2 and x₃ mole-% AIBN (based on the monomer) were dissolved in solvent B resulting in a 50 wt.-% solution. The solution was transferred to a dropping funnel and slowly added drop-wise to solvent A in the reaction flask. After the entire solution had been added, the reaction mixture was stirred for 10 hours while the reaction mixture was allowed to slowly cool to room temperature. Excess solvent was removed in a vacuum. The product was purified by repeated dissolving in suitable solvents and precipitation.

Finally, the product was dried in a vacuum for 24 hours at 50° C. The resulting copolymer was examined by means of IR-spectroscopy, elementary analysis, NMR-spectroscopy and GPC, and the acid value was determined by titration.

Table 4 summarizes the educts used for the preparation of copolymers S4-a to S4-d as well as their amounts and the solvents used.

TABLE 4

| | | x₁ | | x₂ | x₃ | x₄ | | |
|---|---|---|---|---|---|---|---|---|
| Copolymer | a1 | (g) | a2 | (g) | (mole-%) | (wt.-.%) | A | B |
| S4-a | VPA | 35 | PEGMA | 15 | 0.6 | 85 | PROH-W | MEK |
| S4-b | VPA | 15 | PEGMA | 35 | 0.6 | 85 | PROH-W | MEK |
| S4-c | MEDMSPA | 35 | PEGMA | 15 | 0.6 | 85 | PROH-W | MEK |
| S4-d | MEDMSPA | 15 | PEGMA | 35 | 0.6 | 85 | PROH-W | MEK |

### 5. Synthesis Process S5

### Preparation of Copolymers S5-a to S5-l

x₄ wt.-% ionic liquid, consisting of an organic cation and anion, x₁ g a1 and x₂ g a2 were provided in a reaction flask, purged with nitrogen and heated to 70° C. Purging with nitrogen was continued throughout the entire reaction time. Then x₃ mole-% AIBN were added, which was repeated twice at intervals of 2 hours. Then stirring was continued for 10 hours. The precipitated copolymer was isolated, washed with acetonitrile if desired, and then dried in a vacuum for 24 hours at 50° C. The resulting copolymer was examined by means of IR-spectroscopy, elementary analysis, NMR-spectrometry and GPC, and the acid value was determined by titration.

Table 5 summarizes the educts used for the preparation of copolymers S5-a to S5-l as well as their amounts and the solvents used.

TABLE 5

| | | | | | | | | | ionic liquid in |
|---|---|---|---|---|---|---|---|---|---|
| | | x₁ | | x₂ | x₃ | x₄ | | | hydrophilic |
| Copolymer | a1 | (g) | a2 | (g) | (mole-%) | (wt.-%) | Cation | Anion | polymer |
| S5-a | AA | 35 | PEGMA | 15 | 0.13 | 85 | MBIM¹⁰⁾⁺ | BF₄ | 28 |
| S5-b | AA | 35 | PEGMA | 15 | 0.13 | 85 | MBIM⁺ | PF₆⁻ | 15 |
| S5-c | AA | 35 | PEGMA | 15 | 0.13 | 85 | MBIM⁺ | (CH₃O)₂P(O)O⁻ | 58 |
| S5-d | MAA | 35 | PEGMA | 15 | 0.13 | 85 | MBIM⁺ | BF₄⁻ | 62 |
| S5-e | MAA | 35 | PEGMA | 15 | 0.13 | 85 | MBIM⁺ | PF₆⁻ | 67 |
| S5-f | MAA | 35 | PEGMA | 15 | 0.13 | 85 | MBIM⁺ | (CH₃O)₂P(O)O⁻ | 56 |
| S5-g | VPA | 35 | PEGMA | 15 | 0.13 | 85 | MBIM⁺ | BF₄⁻ | 51 |
| S5-h | VPA | 35 | PEGMA | 15 | 0.13 | 85 | MBIM⁺ | PF₆⁻ | 23 |
| S5-i | VPA | 35 | PEGMA | 15 | 0.13 | 85 | MBIM⁺ | (CH₃O)₂P(O)O⁻ | 15 |
| S5-j | AA | 15 | PEGMA | 35 | 0.13 | 85 | MBIM⁺ | BF₄⁻ | 32 |
| S5-k | MAA | 15 | PEGMA | 35 | 0.13 | 85 | MBIM⁺ | BF₄⁻ | 58 |
| S5-l | VPA | 15 | PEGMA | 35 | 0.13 | 85 | MBIM⁺ | BF₄⁻ | 48 |

¹⁰⁾Methyl-3-butylimidazolium

### Comparative Example 1

### Lithographic Substrate with Polyvinylphosphonic Acid Interlayer

An electrochemically grained (with HCl, average roughness 0.6 μm) and anodized aluminum foil (weight of the oxide layer 3.2 g/m²) was subjected to an aftertreatement with an aqueous solution of 1.5 g/l polyvinylphosphonic acid (PVPA) for 10 s at 50° C.

### Examples 1 to 30

The polymer for the interlayer listed in Table 6 was dissolved in the solvent listed in Table 6 so that a 1 wt.-% solution was obtained. The solution was applied onto an aluminum foil as described in Comparative Example 1 (grained and anodized but without PVPA) by means of a bar coating process, left at room temperature for 30 s, rinsed with water for another 30 s and finally dried for 4 minutes at 88° C. The layer weight was determined by determining the amount of organic carbon.

Due to a first interaction between alkaline developer and lithographic substrate, the formation of hydrogen bubbles was observed at the aluminum substrate with interlayer. The developer dwell time that passed until the first bubbles were observed was determined. Goldstar® developer was used as developer, which has a pH value of about 13. The longer the dwell time, the better the aluminum substrate was protected against the developer by the interlayer.

### Etch Test

Goldstar® developer was used for this test as well. An aluminum substrate with interlayer in the form of a strip was immersed in a Goldstar® bath such that a length of 4 cm was covered with developer and left like this for one minute. The process was repeated, wherein each time 4 cm more were immersed and the longest dwell time was 4 minutes.

The resistance to the alkaline attack was evaluated visually by comparing an area of the strip that had not been immersed in developer with the areas that had been immersed for 1, 2, 3 and 4 minutes, respectively.

TABLE 6

| | | | Layer weight | Time until | |
|---|---|---|---|---|---|
| | Interlayer | | of the interlayer | H₂ formation | Etch |
| Example | polymer | Solvent | (mg/m²) | (s) | test¹¹⁾ |
| Comp. 1 | PVPA | water | 15 | 45 | 1 |
| 1 | S1-a | n-propanol:water = 4:1 vol.-% | 13 | 90 | 5 |
| 2 | S1-b | n-propanol:water = 4:1 vol.-% | 11 | 70 | 3 |
| 3 | S1-c | n-propanol:water = 4:1 vol.-% | 14 | 90 | 5 |
| 4 | S1-d | n-propanol:water = 4:1 vol.-% | 13 | 80 | 3 |
| 5 | S2-a | water | 11 | 75 | 3 |
| 6 | S2-b | water | 9 | 85 | 2 |
| 7 | S3-a | n-propanol:water = 4:1 vol.-% | 13 | 75 | 4 |
| 8 | S3-b | n-propanol:water = 4:1 vol.-% | 12 | 90 | 3 |
| 9 | S3-c | n-propanol:water = 4:1 vol.-% | 15 | 85 | 4 |
| 10 | S3-d | n-propanol:water = 4:1 vol.-% | 13 | 80 | 3 |
| 11 | S3-e | n-propanol:water = 4:1 vol.-% | 12 | 85 | 4 |
| 12 | S3-f | n-propanol:water = 4:1 vol.-% | 11 | 90 | 3 |
| 13 | S3-g | n-propanol:water = 4:1 vol.-% | 10 | 85 | 3 |
| 14 | S3-h | n-propanol:water = 4:1 vol.-% | 9 | 90 | 2 |
| 15 | S4-a | n-propanol:water = 4:1 vol.-% | 14 | 80 | 3 |
| 16 | S4-b | n-propanol:water = 4:1 vol.-% | 12 | 90 | 2 |
| 17 | S4-c | n-propanol:water = 4:1 vol.-% | 13 | 90 | 3 |
| 18 | S4-d | n-propanol:water = 4:1 vol.-% | 12 | 80 | 2 |
| 19 | S5-a | n-propanol:water = 4:1 vol.-% | 13 | 90 | 4 |
| 20 | S5-b | n-propanol:water = 4:1 vol.-% | 12 | 95 | 4 |
| 21 | S5-c | n-propanol:water = 4:1 vol.-% | 14 | 80 | 3 |
| 22 | S5-d | n-propanol:water = 4:1 vol.-% | 14 | 125 | 5 |
| 23 | S5-e | n-propanol:water = 4:1 vol.-% | 12 | 100 | 4 |
| 24 | S5-f | n-propanol:water = 4:1 vol.-% | 9 | 90 | 4 |
| 25 | S5-g | n-propanol:water = 4:1 vol.-% | 8 | 95 | 3 |
| 26 | S5-h | n-propanol:water = 4:1 vol.-% | 11 | 85 | 3 |
| 27 | S5-i | n-propanol:water = 4:1 vol.-% | 10 | 80 | 3 |
| 28 | S5-j | n-propanol:water = 4:1 vol.-% | 9 | 95 | 4 |
| 29 | S5-k | n-propanol:water = 4:1 vol.-% | 11 | 90 | 4 |
| 30 | S5-l | n-propanol:water = 4:1 vol.-% | 10 | 100 | 4 |

¹¹⁾Visual evaluation of the interlayer after exposure to Goldstar ® developer:
strong attack after 3 to 4 minutes: 1
clearly visible attack after 4 minutes: 2 (slight improvement)
slight attack after 4 minutes: 3 (clear improvement)
almost no visible attack after 4 minutes: 4 (very clear improvement)
no visible attack after 4 minutes: 5 (excellent improvement)

### Examples 31 to 49 and Comparative Examples 2 to 3

### Lithographic Printing Plate Precursors with UV-Sensitive Photopolymer Layer

An aluminum foil as described in Comparative Example 1 (grained and anodized but without PVPA) was provided with an interlayer; the polymers used can be inferred from Table 8. On top of that, a UV-sensitive coating solution as described in Table 7 was applied and dried.

TABLE 7

| | | |
|---|---|---|
| 1.02 | g | of a terpolymer prepared by polymerization of 470 parts by weight styrene, 336 |
| | | parts by weight methyl methacrylate and 193 parts by weight methacrylic acid, |
| | | 30% solution in propylene glycol monomethylether |
| 0.1 | g | Kayamer PM-2 ® (1 mole phosphoric acid esterified with 1.5 moles |
| | | hydroxyethyl methacrylate) |
| 0.2 | | mercapto-3-triazole |
| 3.92 | g | of an 80% methyl ethyl ketone solution of a urethane acrylate prepared by |
| | | reacting Desmodur N 100 ® with hydroxyethyl acrylate and pentaerythritol |
| | | triacrylate; amount of double bonds: 0.5 double bonds per 100 g when all |
| | | isocyanate groups have completely reacted with the acrylates containing |
| | | hydroxy groups |
| 0.45 | g | ditrimethylolpropane tetraacrylate |
| 1.25 | g | of a dispersion in propylene glycol monomethylether comprising 7.25 wt.-% |
| | | copper phthalocyanine and 7.25 wt.-% of a polyvinylacetal binder comprising 39.9 |
| | | mole-% vinyl alcohol groups, 1.2 mole-% vinyl acetate groups, 15.4 mole-% acetal |
| | | groups derived from acetaldehyde, 36.1 mole-% acetal groups derived from butyric |
| | | aldehyde and 7.4 mole-% acetal groups derived from 3-formylbenzoic acid |
| 0.25 | g | 2-phenyl-4-(2-chlorophenyl)-5-(4-diethylaminophenyl)-oxazole |
| 0.175 | g | 2,2-bis(2-chlorophenyl)-4,5,4′,5′-tetraphenyl-2′H-[1,2′]-biimidazolyl |
| 20 | ml | propylene glycol monomethylether |
| 16 | ml | methanol |
| 25 | ml | methyl ethyl ketone |

The solution was filtered, applied onto the lithographic substrate and the coating was dried for 4 minutes at 90° C. The dry layer weight of the photopolymer layer was about 1.5 g/m².

The obtained samples were coated with an overcoat by applying an aqueous solution of poly(vinylalcohol) (degree of hydrolysis: 88%); after drying for 4 minutes at 90° C., the overcoat layer had a dry layer weight of about 3 g/m².

The printing plate precursor was exposed with a tungsten lamp having a metal interference filter through a gray scale having a tonal range of 0.15 to 1.95, wherein the density increments amounted to 0.15 (UGRA gray scale) with 1 μW/cm². Immediately after exposure, the plate was heated in an oven for 2 minutes at 90° C.

Then the exposed plate precursor was treated for 30 seconds with a developer solution having a pH value of 10 and containing KOH as alkaline component.

Then the developer solution was again rubbed over the surface for another 30 seconds using a tampon and then the entire plate was rinsed with water. After this treatment, the exposed portions remained on the plate. For the assessment of its photosensitivity, the plate was blackened in a wet state with printing ink.

For the assessment of storage stability, the unexposed printing plate precursors were stored for 60 minutes in a 90° C. oven, then exposed and developed as described above (storage stability test).

For the preparation of a lithographic printing plate, a printing layer was applied to the aluminum foil as explained above, exposed, heated, developed, and after rinsing with water, the developed plate was wiped and rubbed with an aqueous solution of 0.5% phosphoric acid and 6% gum arabic. The thus prepared plate was loaded in a sheet-fed offset printing machine and an abrasive printing ink (Offset S 7184®, containing 10% potassium carbonate) was used. The results are summarized in Table 8.

The term “dot gain” describes the change in the tonal values of a linearized plate. Linearization means that a digital plate is exposed such that a predetermined set tonal value (STV) is approximately obtained. The accessible measured values are the tonal values (TV). They are exposed onto the linearized plate in different magnitudes (index i in formula 1) resulting in a differentiated image with respect to the tonal values, depending on the selection of these magnitudes. Thus, a series of data of tonal values before printing (TVB) is obtained. The linearized, developed and, according to the present invention, aftertreated printing plate is used in a press for 10,000 prints, cleaned and then again subjected to a tonal value examination, which shows the tonal values after printing (TVA). Then the dot gain is calculated using equation (1).

$$Dot gain = {\sum }_{i} ( ( TVB [ i ] - STV [ i ] ) + ( TVA [ i ] - STV [ i ] ) ) \qquad ( 1 )$$

The dot gain can have either a positive or a negative sign. It is merely the absolute value which is of interest for practical printing applications, which in an ideal case should converge towards zero.

In other words: The lower the dot gain, the better the plate.

The plate of Comparative Example 2, i.e. a plate with considerable dot gain during printing at different tonal values, is used as a reference. The relative dot gain is calculated using equation (2) below:

$$relative dot gain = \frac{dot gain ( sample )}{dot gain ( reference )} \cdot 100 \% \qquad ( 2 )$$

It can be inferred from Table 8 that a UV-sensitive printing plate precursor with an interlayer according to the present invention provides a high degree of sensitivity, good storage stability, improved resistance to strongly alkaline developers, reduced dot change (dot gain) and a high print run stability.

TABLE 8

| | | Energy | Energy required | | |
|---|---|---|---|---|---|
| | | required for | for imaging at | | |
| | | imaging | 405 nm | | |
| | Interlayer | at 405 nm¹²⁾ | 60 min/90° C.¹³⁾ | Relative dot gain | |
| Example | polymer | (μm/cm²) | (μm/cm²) | (relative area) | Number of copies |
| Comp. 2 | PVPA | 170 | 170 | 100 | >50,000 |
| Comp. 3 | U.S. Pat. No. 5,807,569 | 170 | 170 | toning problems, | toning problems, not |
| | (Example 9) | | | not acceptable in | acceptable in |
| | | | | practical | practical applications |
| | | | | applications | |
| 31 | S1-a | 130 | 130 | 60 | >50,000 |
| 32 | S1-b | 120 | 120 | 30 | >50,000 |
| 33 | S2-a | 110 | 110 | 5 | >50,000 |
| 34 | S2-b | 130 | 130 | 10 | >50,000 |
| 35 | S3-e | 120 | 130 | 30 | >50,000 |
| 36 | S3-f | 110 | 120 | 20 | >50,000 |
| 37 | S3-g | 130 | 130 | 10 | >50,000 |
| 38 | S3-h | 110 | 120 | 20 | >50,000 |
| 39 | S3-i | 120 | 120 | 20 | >50,000 |
| 40 | S3-j | 130 | 120 | 10 | >50,000 |
| 41 | S4-a | 130 | 130 | 5 | >50,000 |
| 42 | S5-a | 120 | 130 | 40 | >50,000 |
| 43 | S5-b | 120 | 130 | 50 | >50,000 |
| 44 | S5-c | 130 | 130 | 70 | >50,000 |
| 45 | S5-d | 130 | 140 | 50 | >50,000 |
| 46 | S5-g | 120 | 120 | 5 | >50,000 |
| 47 | S5-j | 120 | 120 | 40 | >50,000 |
| 48 | S5-k | 130 | 130 | 50 | >50,000 |
| 49 | S5-l | 130 | 140 | 50 | >50,000 |

¹²⁾Energy required for obtaining a gray scale step of a UGRA ® gray scale on the fresh plate
¹³⁾Storage stability test: Energy required for obtaining a gray scale step of a UGRA ® gray scale on a plate stored at 90° C. for 60 min

The dot gain of Comparative Example 2 and Example 33 is illustrated in FIG. 1 and FIG. 2, respectively.

### Examples 50 to 72 and Comparative Examples 4 to 10

### 1. Polymer Synthesis

Using common methods, the interlayer polymers were prepared from the monomers/oligomers given in Table 9.

For example, the polymer used in Example 49 was prepared as follows:

90 g EtOAc were provided in a 300 ml four-necked flask in a nitrogen atmosphere and heated to 70° C. 14.9 g vinylphosphonic acid, 15.4 g polyethylene glycol methacrylate (Mw=438), 6.6 g polyethylene glycol methacrylate (Mw=174) and 1.3 g azobisisobutyronitrile were mixed with 25 g EtOAc; over a time period of 2 hours, the mixture was added drop-wise to the flask while the temperature was held at 70° C. After 4 more hours at 70° C., 65 g deionized water were added and the mixture was stirred for 30 minutes. EtOAc was distilled off under reduced pressure, then 40 g of deionized water were added and finally more EtOAc was distilled off.

The monomers/oligomers used for the polymer of each example, their ratio in wt.-% as well as the solvent used for polymerization can be inferred from Table 9.

### 2. Production of Printing Plate Precursors

An electrochemically grained and anodized aluminum foil was immersed for 20 s in a 60° C. solution of each polymer listed in Table 9 (2 g/l), then washed with deionized water, dried for 60 s at 100° C. and provided with a radiation-sensitive layer after cooling. The examples marked “a” refer to a printing plate precursor of a negative working plate without preheating, while the examples marked “b” refer to a printing plate precursor of a developing-free plate (the term “developing-free” means that no developer solution is required to remove the non-image areas of the coating, but the non-image areas are removed by means of printing ink and/or fountain solution).

The following composition was used in the production of the IR-sensitive layer of the “negative plate without preheating”:

| | | |
|---|---|---|
| Methylcellosolve | 66.42 | wt.-% |
| WPI-044 (onium salt) | 0.615 | wt.-% |
| Methyl ethyl ketone | 25.66 | wt.-% |
| NPP-33 (allyl-MA/AN/H₂C═CH—CO—NH—Ph—COOH- | 3.38 | wt.-% |
| copolymer) | | |
| Dipentaerythritol hexaacrylate | 2.864 | wt.-% |
| P3B (borate) | 0.388 | wt.-% |
| IRT (IR dye) | 0.184 | wt.-% |
| D-11 (colorant) | 0.307 | wt.-% |
| DC-190 (surfactant of the silicone type) | 0.02 | wt.-% |
| SAS-1 (tenside) | 0.06 | wt.-% |
| 2,2-Methylene-bis(6-t-butyl-4-methylphenol) | 0.102 | wt.-% |

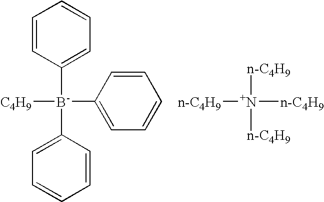

P3B 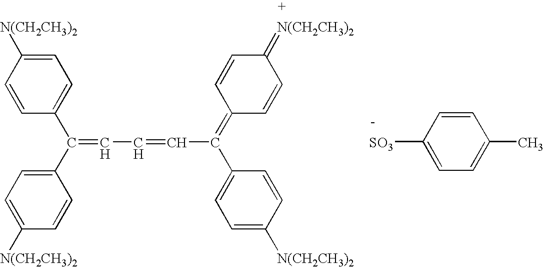
IRT 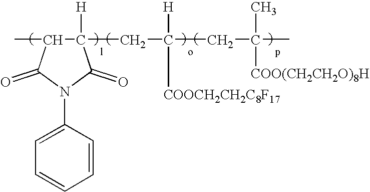
SAS-1D11I:O:P = 44:37:19

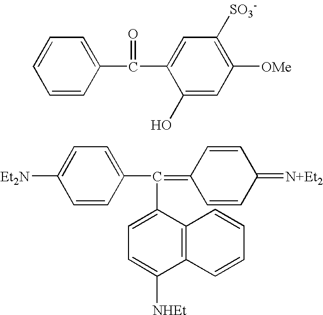

### WPI-044:

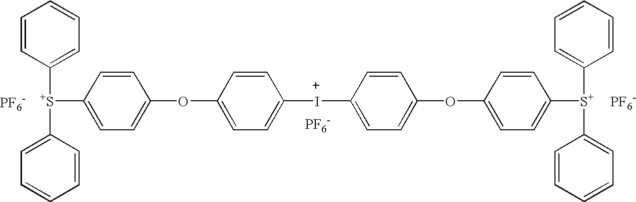

### NPP-33:

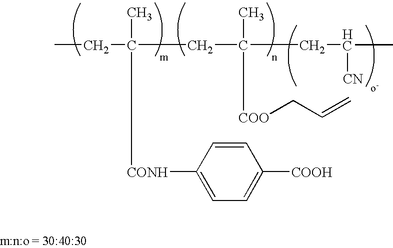

The dry layer weight was 1.35 g/m².

The following composition was used in the production of the “developing-free plate”:

| | | |
|---|---|---|
| ACR-1559 (polyethylene glycol methylether-methacrylate-styrene copolymer) | 3.7 | wt.-% |
| ACR-1563 (allylmethacrylate-styrene copolymer) | 0.39 | wt.-% |
| UR-4387 (polyurethane with double bonds in the side chain and a unit | 0.99 | wt.-% |
| capable of forming quadrupole hydrogen bonds) | | |
| SR399 (dipentaerythritol pentaacrylate from Sartomer) | 0.99 | wt.-% |
| Irgacure250 (diphenyliodonium derivative with hexafluorophosphate | 0.32 | wt.-% |
| anion from Ciba Specialty Chemicals) | | |
| KAN51429 (IR absorber) | 0.07 | wt.-% |

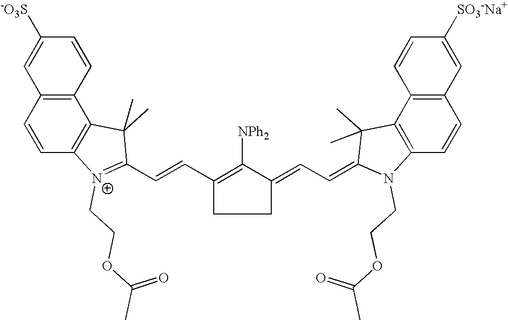

KAN51429

| | | |
|---|---|---|
| BYK336 (tenside) | 0.15 | wt.-% |
| 1-Propanol | 74.71 | wt.-% |
| Water | 18.68 | wt.-% |

The dry layer weight was 1.40 g/m².

### 3. Examination of Adhesion in the Developing-Free Plate

After exposure with a Creo image-setter 3244 (830 nm; 200 mJ/cm²), the plate was wiped 5 times with a cloth wetted with fountain solution (containing 1% isopropanol and 1% fountain solution from DIC) and then 5 times with a cloth wetted with printing ink (manual developing). The image areas of the “manually developed” plates were then rubbed vigorously 20 times with a cloth wetted with fountain solution (“rub test”).

The plates were evaluated as to whether and to what degree the image areas were damaged by manual development and/or the rub test; the following criteria were used for the evaluation:
A neither manual development nor rub test caused damage to image areas on the plate
B no damage from manual developing, only slight damage from rub test
C no damage from manual developing, marked damage from rub test
D moderate damage from manual developing; no rub test was carried out
E after manual developing no image areas remained on plate; no rub test was carried out
“−” indicates that the results were somewhat worse than expressed by the letter given.
“+” indicates that the results were somewhat better than expressed by the letter given.
“C-D” indicates that the result was between categories C and D.

The results can be inferred from Table 9.

### 4. Examination of Toning in the Developing-Free Plate

### Test 1

A cloth wetted with printing ink was rubbed lightly over the dampened non-image areas of the manually developed plate.

### Test 2

When the non-image areas accepted printing ink during Test 1, the plate was rinsed with water and the non-image areas were evaluated.

The following criteria were used for the evaluation:
A completely clean non-image areas after manual developing; completely clean non-image areas after Test 1
B completely clean non-image areas after manual developing; slight printing ink residue in non-image areas after Test 1; no printing ink residues after Test 2
C completely clean non-image areas after manual developing; moderate printing ink residue in non-image areas after Test 1; no-printing ink residues after Test 2
D slight printing ink residue after manual developing; no toning test was carried out
E very clear printing ink residues after manual developing; no toning test was carried out

The results can be inferred from Table 9.

### 5. Evaluation of the Negative Plates without Preheating

After exposure with a Creo image-setter 3244 (830 nm; 120 mJ/cm²) the plates were immersed in developer solution (27° C., 20 s) consisting of 350 ml water, 30 ml sodium salt of alkylnaphthalene sulfonic acid (anionic tenside) and 5.5 ml potassium silicate; subsequently, the plate was washed with water for 10 s (manual developing).

The thus developed plates were then subjected to the rub test as described above in connection with the developing-free plates. A cloth wetted with tap water was used for the “rub test”. Again, the plates were evaluated using the criteria A to E.

With respect to toning, Tests 1 and 2 as described above in connection with developing-free plates were carried out; the plates were also evaluated using the criteria A to E as described above for developer-free plates.

The results can be inferred from Table 9.

### 6. Results

The following abbreviations were used in Table 9:
VPA: Vinylphosphonic acid (CH₂═CH—PO₃H₂)
MAA: Methacrylic acid
AE-350: Polyethylene glycol acrylate, Mw=424
PE-350: Polyethylene glycol methacrylate, Mw=438
AE-200: Polyethylene glycol acrylate, Mw=270
AE-90: Polyethylene glycol acrylate, Mw=160
PE-90: Polyethylene glycol methacrylate, Mw=174
AMPS: 2-Acrylamido-2-methyl-1-propansulfonic acid from Aldrich
PVAM: Polyvinyl alcohol methacrylate
AMA: Allylmethacrylate
St: Styrene
Phosmer PE: Polyethylene glycol methacrylate phosphoric acid monoester from Uni-chemical
NVIM: N-Vinylimidazole
EtOAc: Ethyl acetate
PEG: Polyethylene glycol

The numbers given behind the monomers/oligomers indicate the wt.-% of the respective monomer/oligomer, based on all monomers/oligomers used for the polymer.

The solvent mentioned was used in the preparation of the polymer.

TABLE 9

| | | | | | Negative | | | |
|---|---|---|---|---|---|---|---|---|
| | | PEG | | | plate without | | Developing- | |
| | Monomer | macromer | Additional | | preheating | | free plate | |
| Example | (a2) | (a1) | monomer | Solvent | Toning | adhesion | Toning | adhesion |
| Comp. | VPA/24 + | | AMPS/19 | EtOAc | A | E | A | E+ |
| 4a + b | MAA/57 | | | | | | | |
| Comp. | VPA/10 + | | PVAM/66 | EtOAc | A | E | A | E+ |
| 5a + b | MAA/24 | | | | | | | |
| 50a + b | VPA/30 | AE-350/70 | | EtOAc | A | C-D | A | D+ |
| 51a + b | VPA/30 | PE-350/70 | | EtOAc | A | C-D | B | C |
| Comp. | VPA/33 + | | NVIM/33 | EtOAc | E | A | E | A |
| 6a + b | MAA/33 | | | | | | | |
| Comp. | VPA/30 | | NVIM/70 | EtOAc | E | A | E | A |
| 7a + b | | | | | | | | |
| Comp. | VPA/30 + | | AMA/35 | EtOAc | E | A | E | A |
| 8a + b | MAA/35 | | | | | | | |
| Comp. | VPA/40 | | NVIM/60 | EtOAc | E | A | C | C |
| 9a + b | | | | | | | | |
| 52a + b | VPA/35 | AE-350/65 | | EtOAc | A | D | A | C |
| 53a + b | VPA/50 | AE-350/50 | | Water | A | D | A | D |
| 54a + b | VPA/35 | PE-350/65 | | Water | A | D | A | D |
| 55a + b | VPA/50 | AE-350/44 | St/6 | EtOAc to | A | D | C | A |
| | | | | H₂O | | | | |
| Comp. | VPA/30 | | NVIM/70 | Water | D | A | E | A |
| 10a + b | | | | | | | | |
| Comp. | VPA/40 | | NVIM/60 | Water | E | A | E | A |
| 11a + b | | | | | | | | |
| 56a + b | VPA/28 | AE-90/72 | | EtOAc to | A | D | A | C |
| | | | | H₂O | | | | |
| 57a + b | VPA/28 | AE-200/72 | | EtOAc to | A | D | A | C− |
| | | | | H₂O | | | | |
| 58a + b | VPA/40 | AE-90/60 | | EtOAc to | A | D | A | D |
| | | | | H₂O | | | | |
| 59a + b | VPA/28 | PE-90/72 | | Water | A | D | C | A |
| 60a + b | VPA/40 | PE-90/60 | | Water | A | C | C | A |
| 61a + b | VPA-/60 | AE-350/40 | | EtOAc | A | D | A | D |
| 62a + b | VPA/28.4 | PE- | St/3 | EtOAc to | A | D | B− | A |
| | | 350/68.6 | | H₂O | | | | |
| 63a + b | VPA/50 | PE-350/47 | St/3 | EtOAc to | A | C | B− | B+ |
| | | | | H₂O | | | | |
| 64a + b | VPA/40 | PE-350/42 | AE-90/18 | EtOAc to | A | D | A | B |
| | | | | H₂O | | | | |
| 65a + b | VPA/40 | PE-350/30 | AE-90/30 | EtOAc to | A | D | B | A |
| | | | | H₂O | | | | |
| 66a + b | VPA/60 | Phosmer | | Water | A | C | B | D |
| | | PE/40 | | | | | | |
| 67a + b | VPA/50 | Phosmer | NVIM/10 | Water | A | D | A | C− |
| | | PE/40 | | | | | | |
| 68a + b | VPA/40 | Phosmer | NVIM/10 | Water | A | D | A | B |
| | | PE/50 | | | | | | |
| 69a + b | VPA/28.4 | PE- | | Water | A | D | B | B− |
| | | 350/62.6 | | | | | | |
| 70a + b | VPA/50 | PE-350/43 | | Water | A | D | A | D |
| 71a + b | VPA/40 | PE-350/42 | PE-90/18 | Water | A | C | A | C+ |
| 72a + b | VPA/40 | PE-350/30 | PE-90/30 | EtOAc | A | D | B− | C |

1. Lithographic substrate comprising
(a) a dimensionally stable plate- or foil-shaped support,
(b) an aluminum oxide layer provided on at least one side of the support (a), and
(c) an interlayer applied onto the aluminum oxide layer comprising a hydrophilic polymer comprising structural units derived from the following compounds:
(a1) at least one compound comprising both polyalkylene oxide chains and at least one structural unit which is free-radical polymerizable,
and
(a2) at least one monomer capable of copolymerizing with the free-radical polymerizable structural unit of (a1) and furthermore comprising at least one acidic functional group with pKₛ<5, wherein the acidic functional group can be present as a free acid group or in the form of a salt.

2.-3. (canceled)

4. Lithographic substrate according to claim 1 wherein the layer weight of the aluminum oxide layer is 1.5 to 5 g/m².

5. Lithographic substrate according to claim 1 wherein the polymer furthermore comprises (i) structural units derived from at least one comonomer (a3) different from monomer (a2) and comprising at least one free-radical polymerizable group, which comonomer can be used to adjust the physical properties of the polymer, and/or (ii) structural units derived from at least one hydrophobic comonomer (a4) comprising at least one free-radical polymerizable group.

6. Lithographic substrate according to claim 1
wherein the compound (a1) is at least one compound selected from
Poly(ethylene glycol) methacrylate,
poly(ethylene glycol) acrylate,
poly(propylene glycol) methacrylate,
poly(propylene glycol) acrylate,
monoesters of acrylic acid or methacrylic acid with block copolymers of ethylene oxide and/or propylene oxide,
the reaction product of 2,4-toluene diisocyanate-terminated polyethylene glycol, polypropylene glycol, block copolymer of polyethylene glycol and polypropylene glycol or statistical poly(ethylene glycol-propylene glycol) copolymer with hydroxyalkyl acrylate or methacrylate or allyl alcohol, the monoreaction product of isocyanatoalkyl acrylate or methacrylate with polyethylene glycol, polypropylene glycol, block copolymer of polyethylene glycol and polypropylene glycol or statistical poly(ethylene glycol-propylene glycol) copolymer,
ester or ether derivatives of poly(alkylene glycol) acrylate and methacrylate.

7. Lithographic substrate according to claim 1 wherein the monomer (a2) is at least one monomer selected from acrylic acid, methacrylic acid, crotonic acid, maleic acid anhydride decyclized with a C₁-C₆ alkanol, vinylbenzoic acid, vinylphosphonic acid, vinylsulfonic acid, vinylbenzolsulfonic acid, monoesters of phosphoric acid with hydroxyalkyl(meth)acrylate or allyl alcohol and sulfopropyl (meth)acryloylethyldialkylammoniumhydroxides.

8. Lithographic substrate according to claim 5, wherein the comonomer (a3) is at least one comonomer selected from (meth)acrylamide, N-vinylpyrrolidone, hydroxyalkyl(meth)acrylate, allyl alcohol and N-vinylimidazole.

9. Lithographic substrate according to claim 1 wherein the structural units derived from (a1) account for 5 to 95 wt.-%, the structural units derived from (a2) account for 5 to 95 wt.-% and the structural units derived from (a3) account for 0 to 50 wt.-%, each based on the total amount of structural units of the polymer.

10. Lithographic substrate according to claim 1, wherein the hydrophilic polymer was prepared by solvent polymerization in an ionic liquid.

11. Lithographic substrate according to claim 10, wherein the polymer still comprises ionic liquid.

12. Lithographic printing plate precursor comprising
(a) a lithographic substrate as defined in claims 1, and
(b) one or more radiation-sensitive layers.

13. Printing plate precursor according to claim 12, wherein the radiation-sensitive layer is a positive working layer.

14. Printing plate precursor according to claim 12, wherein the radiation-sensitive layer is a negative working layer.

15. Printing plate precursor according to claim 12 wherein the radiation-sensitive layer is a UV-sensitive layer sensitive to radiation of a wavelength selected from the range of 320 to 750 nm.

16. Printing plate precursor according to claim 12, wherein the radiation-sensitive layer is an IR-sensitive layer sensitive to radiation of a wavelength selected from the range of more than 750 to 1,600 nm.

17. Lithographic printing plate comprising image areas and non-image areas on a lithographic substrate as defined in claim 1.

18. Process for the production of a lithographic substrate as defined in claim 1 comprising
(a) providing a dimensionally stable plate- or foil-shaped support with an aluminum oxide layer;
(b) providing a solution comprising a hydrophilic polymer comprising structural units derived from the following compounds:
(a1) at least one compound comprising both polyalkylene oxide chains and at least one structural unit which is free-radical polymerizable,
and
(a2) at least one monomer capable of copolymerizing with the free-radical polymerizable structural unit of (a1) and furthermore comprising at least one acidic functional group with pKₛ<5, wherein the acidic functional group can be present as a free acid group or in the form of a salt;
(c) applying the solution of step (b) onto the substrate;
(d) drying at a temperature from 30 to 120° C.

19. Process according to claim 18, wherein the hydrophilic polymer furthermore comprises (i) structural units derived from a comonomer (a3) different from monomer (a2) and comprising at least one free-radical polymerizable group, which comonomer can be used to adjust the physical properties of the polymer, and/or (ii) structural units derived from at least one hydrophobic comonomer (a4) comprising at least one free-radical polymerizable group.

20. Process according to claim 18, wherein the solution provided in step (b) contains the polymer in a concentration of 0.01 to 10 wt.-%, based on the solvent.

21. Process according to claim 18, wherein between steps (c) and (d) excess solution is removed by means of a doctor blade, a squeeze roll or by rinsing with water.

22. Process for the production of a lithographic printing plate precursor as defined in claim 12 comprising
(a) providing a lithographic substrate as defined in claim 1, and
(b) providing one or more radiation-sensitive compositions and applying them onto the lithographic substrate provided in step (a).

23. (canceled)
